(19) United States
(12) Patent Application Publication
(10) Pub. No.: US 2009/0326945 A1
(43) Pub. Date: Dec. 31, 2009

(54) METHODS, APPARATUSES, AND COMPUTER PROGRAM PRODUCTS FOR PROVIDING A MIXED LANGUAGE ENTRY SPEECH DICTATION SYSTEM

(75) Inventor: Jilei Tian, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/146,987

(22) Filed: Jun. 26, 2008

(51) Int. Cl. G10L 15/04; G10L 15/18

(52) U.S. Cl. 704/254; 704/257; 704/E15.005; 704/E15.018

(57) ABSTRACT

An apparatus may include a processor configured to receive vocabulary entry data. The processor may be further configured to determine a class for the received vocabulary entry data. The processor may be additionally configured to identify one or more languages for the vocabulary entry data based upon the determined class. The processor may also be configured to generate a phoneme sequence for the vocabulary entry data for each identified language. Corresponding methods and computer program products are also provided.

### TECHNOLOGICAL FIELD

Embodiments of the present invention relate generally to mobile communication technology and, more particularly, relate to methods, apparatuses, and computer program products for providing a mixed language entry speech dictation system.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the convenience to users is the provision of speech dictation systems capable of handling mixed language entries. In this regard, hands-free speech dictation is becoming a more prevalent and convenient means of input of data into computing devices for users. The use of speech dictation as an input means may be particularly useful and convenient for users of mobile computing devices, which may have smaller and more limited means of input than, for example, standard desktop or laptop computing devices. Such speech dictation systems employing automatic speech recognition (ASR) technology may be used to generate text output from speech input and thus facilitate, for example, the composition of e-mails, text messages and appointment entries in calendars as well as facilitate other data entry and composition tasks. However, as the world becomes increasingly globalized, speech input increasingly has become comprised of mixed languages. In this regard, even though a computing device user may be predominantly monolingual and dictate a phrase structured in the user's native language, the user may dictate words within the phrase that are in different languages, such as, for example, names of people and locations that may be in a language foreign to the user's native language. An example of such a mixed language input may be the sentence, “I have a meeting with Peter, Javier, Gerhard, and Miika.” Although the context of the sentence is clearly in English, the sentence includes Spanish (Javier), German (Gerhard), and Finnish (Miika) names. Further, even the name “Peter” is native to multiple languages, each of which may define a different pronunciation for the name. It is important for speech dictation systems to be able to correctly recognize and handle these mixed language inputs including foreign language names, however, as these names convey important information for understanding and utilizing any resulting textual output.

Unfortunately, existing speech dictation systems are mostly monolingual in nature and may not accurately handle mixed language entry without requiring additional user input to identify mixed language entries. Additionally, current multilingual speech dictation systems may be costly to implement in terms of use of computing resources, such as memory and processing power. This computing resource cost may pose a particular barrier for the implementation of multilingual speech dictation systems in mobile computing devices. Accordingly, it may be advantageous to provide computing device users with methods, apparatuses, and computer program products for providing an improved mixed language entry speech dictation system.

### BRIEF SUMMARY OF SOME EXAMPLES OF THE INVENTION

A method, apparatus, and computer program product are therefore provided, which may provide an improved mixed language entry speech dictation system. In particular, a method, apparatus, and computer program product are provided to enable, for example, the automatic speech recognition of mixed language entries. Embodiments of the invention may be particularly advantageous for users of mobile computing devices as embodiments of the invention may provide a mixed language entry speech dictation system that may limit use of computing resources while still providing the ability to handle mixed language entries.

In one exemplary embodiment, a method is provided which may include receiving vocabulary entry data. The method may further include determining a class for the received vocabulary entry data. The method may additionally include identifying one or more languages for the vocabulary entry data based upon the determined class. The method may also include generating a phoneme sequence for the vocabulary entry data for each identified language.

In another exemplary embodiment, a computer program product is provided. The computer program product includes at least one computer-readable storage medium having computer-readable program code portions stored therein. The computer-readable program code portions may include first, second, third, and fourth program code portions. The first program code portion is for receiving vocabulary entry data. The second program code portion is for determining a class for the received vocabulary entry data. The third program code portion is for identifying one or more languages for the vocabulary entry data based upon the determined class. The fourth program code portion is for generating a phoneme sequence for the vocabulary entry data for each identified language.

In another exemplary embodiment, an apparatus is provided, which may include a processor. The processor may be configured to receive vocabulary entry data. The processor may be further configured to determine a class for the received vocabulary entry data. The processor may be additionally configured to identify one or more languages for the vocabulary entry data based upon the determined class. The processor may also be configured to generate a phoneme sequence for the vocabulary entry data for each identified language.

In another exemplary embodiment, an apparatus is provided. The apparatus may include means for receiving vocabulary entry data. The apparatus may further include means for determining a class for the received vocabulary entry data. The apparatus may additionally include means for identifying one or more languages for the vocabulary entry data based upon the determined class. The apparatus may also include means for generating a phoneme sequence for the vocabulary entry data for each identified language.

The above summary is provided merely for purposes of summarizing some example embodiments of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described some embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an example system for providing a mixed language entry speech dictation system;

FIG. 4 illustrates a block diagram of a speech dictation system according to an exemplary embodiment of the present invention;

FIG. 5 illustrates a block diagram of a system for providing mixed language vocabulary entries for a mixed language speech dictation system according to an exemplary embodiment of the present invention; and

FIG. 6 is a flowchart according to an exemplary method for providing a mixed language entry speech dictation system according to an exemplary embodiment of the present invention.

### DETAILED DESCRIPTION OF SOME EMBODIMENTS OF THE INVENTION

Some embodiments of the invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

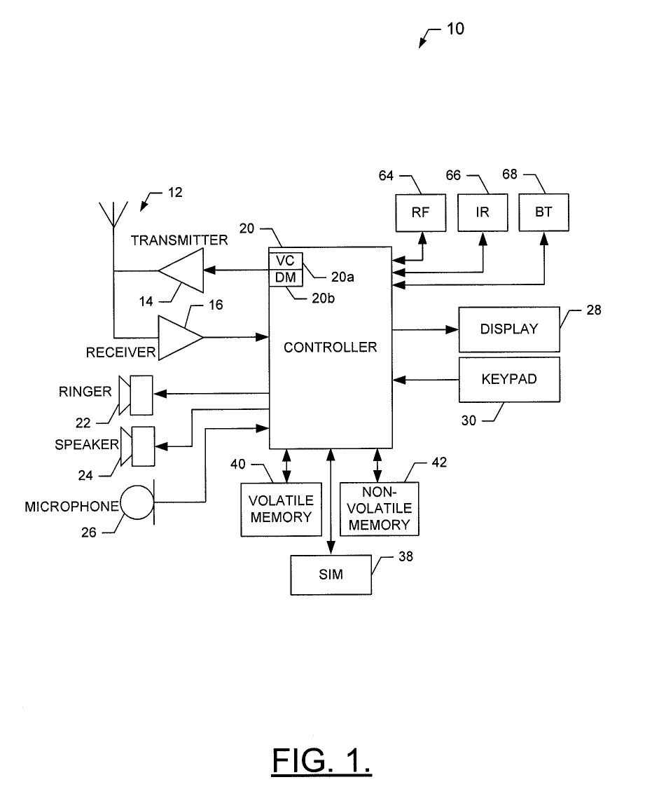

FIG. 1 illustrates a block diagram of a mobile terminal 10 that may benefit from embodiments of the present invention. It should be understood, however, that the mobile terminal illustrated and hereinafter described is merely illustrative of one type of electronic device that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

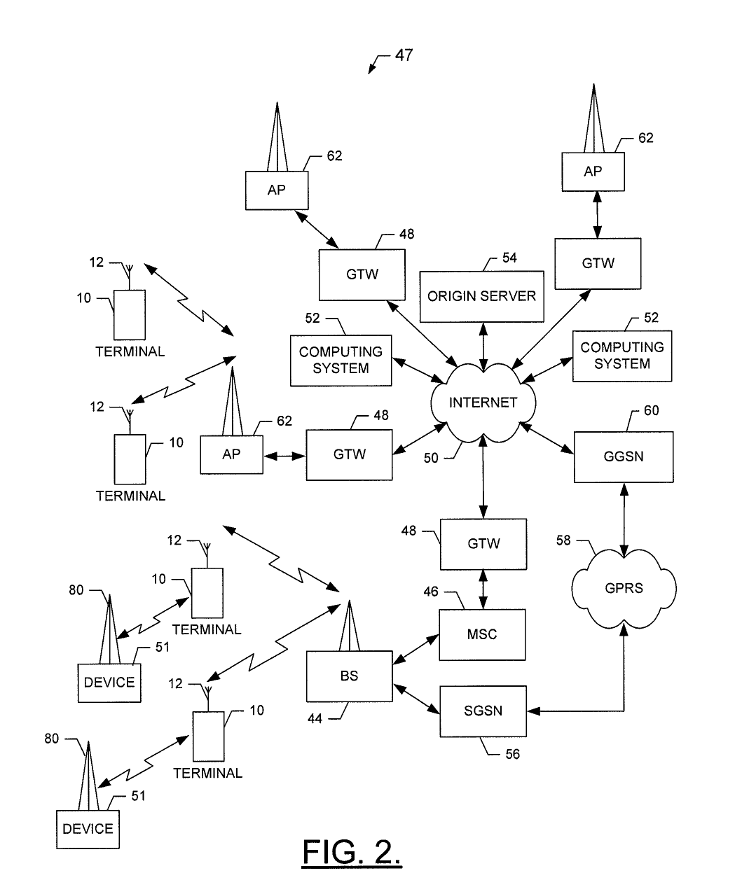

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across internet 50 of FIG. 2.

The mobile terminal 10 may also comprise a user interface including, for example, an earphone or speaker 24, a ringer 22, a microphone 26, a display 28, a user input interface, and/or the like, which may be operationally coupled to the controller 20. As used herein, “operationally coupled” may include any number or combination of intervening elements (including no intervening elements) such that operationally coupled connections may be direct or indirect and in some instances may merely encompass a functional relationship between components. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Referring now to FIG. 2, an illustration of one type of system that may support communications to and from an electronic device, such as the mobile terminal of FIG. 1, is provided by way of example, but not of limitation. As shown, one or more mobile terminals 10 may each include an antenna 12 (or multiple antennas 12) for transmitting signals to and for receiving signals from a base site or base station (BS) 44. The base station 44 may be a part of one or more cellular or mobile networks each of which may comprise elements desirable to operate the network, such as a mobile switching center (MSC) 46. In operation, the MSC 46 may be capable of routing calls to and from the mobile terminal 10 when the mobile terminal 10 is making and receiving calls. The MSC 46 may also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network or a network employing an MSC.

The MSC 46 may be operationally coupled to a data network, such as a local area network (LAN), a metropolitan area network (MAN), a wide area network (WAN), and/or the like. The MSC 46 may be directly coupled to the data network. In one example embodiment, however, the MSC 46 may be operationally coupled to a gateway (GTW) 48, and the GTW 48 may be operationally coupled to a WAN, such as the Internet 50. In turn, devices such as processing elements (e.g., personal computers, server computers and/or the like) may be operationally coupled to the mobile terminal 10 via the Internet 50. For example, as explained below, the processing elements may include one or more processing elements associated with a computing system 52 (two shown in FIG. 2), origin server 54 (one shown in FIG. 2) and/or the like, as described below.

As shown in FIG. 2, the BS 44 may also be operationally coupled to a signaling General Packet Radio Service (GPRS) support node (SGSN) 56. As known to those skilled in the art, the SGSN 56 may be capable of performing functions similar to the MSC 46 for packet switched services. The SGSN 56, like the MSC 46, may be operationally coupled to a data network, such as the Internet 50. The SGSN 56 may be directly coupled to the data network. Alternatively, the SGSN 56 may be operationally coupled to a packet-switched core network, such as a GPRS core network 58. The packet-switched core network may then be operationally coupled to another GTW 48, such as a Gateway GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as short message service (SMS), instant messages (IM), multimedia messaging service (MMS) messages, and/or e-mails. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown in FIG. 2 and described herein, it should be appreciated that electronic devices, such as the mobile terminal 10, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, IS-95 (CDMA), and/or the like. Also, for example, one or more of the network(s) may be capable of supporting communication in accordance with 2.5G wireless communication protocols GPRS, Enhanced Data GSM Environment (EDGE), and/or the like. Further, for example, one or more of the network(s) may be capable of supporting communication in accordance with 3G wireless communication protocols such as E-UTRAN or a Universal Mobile Telephone System (UMTS) network employing Wideband Code Division Multiple Access (WCDMA) radio access technology. Some NAMPS, as well as TACS, network(s) may also benefit from embodiments of the present invention, as should dual or higher mode mobile terminals (e.g., digital/analog or TDMA/CDMA/analog phones).

As depicted in FIG. 2, the mobile terminal 10 may further be operationally coupled to one or more wireless access points (APs) 62. The APs 62 may comprise access points configured to communicate with the mobile terminal 10 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, Worldwide Interoperability for Microwave Access (WiMAX) techniques such as IEEE 802.16, Wireless-Fidelity (Wi-Fi) techniques and/or ultra wideband (UWB) techniques such as IEEE 802.15 or the like. The APs 62 may be operationally coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly coupling the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of operationally coupling the mobile terminal 10 to computing systems 52 and/or origin server 54 across the Internet 50, the mobile terminal 10, computing system 52 and origin server 54 may be operationally coupled to one another and communicate in accordance with, for example, RF, BT, IrDA and/or any of a number of different wireline or wireless communication techniques, including LAN, WLAN, WiMAX, Wireless Fidelity (Wi-Fi), Wibree™, UWB techniques, and/or the like. One or more of the computing systems 52 may additionally, or alternatively, include a removable memory capable of storing content, which can thereafter be transferred to the mobile terminal 10. Further, the mobile terminal 10 may be operationally coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA and/or any of a number of different wireline or wireless communication techniques, including USB, LAN, Wibree™, Wi-Fi, WLAN, WiMAX and/or UWB techniques. In this regard, the mobile terminal 10 may be capable of communicating with other devices via short-range communication techniques. For instance, the mobile terminal 10 may be in wireless short-range communication with one or more devices 51 that are equipped with a short-range communication transceiver 80. The electronic devices 51 may comprise any of a number of different devices and transponders capable of transmitting and/or receiving data in accordance with any of a number of different short-range communication techniques including but not limited to Bluetooth™, RFID, IR, WLAN, Infrared Data Association (IrDA) and/or the like. The electronic device 51 may include any of a number of different mobile or stationary devices, including other mobile terminals, wireless accessories, appliances, portable digital assistants (PDAs), pagers, laptop computers, motion sensors, light switches and other types of electronic devices.

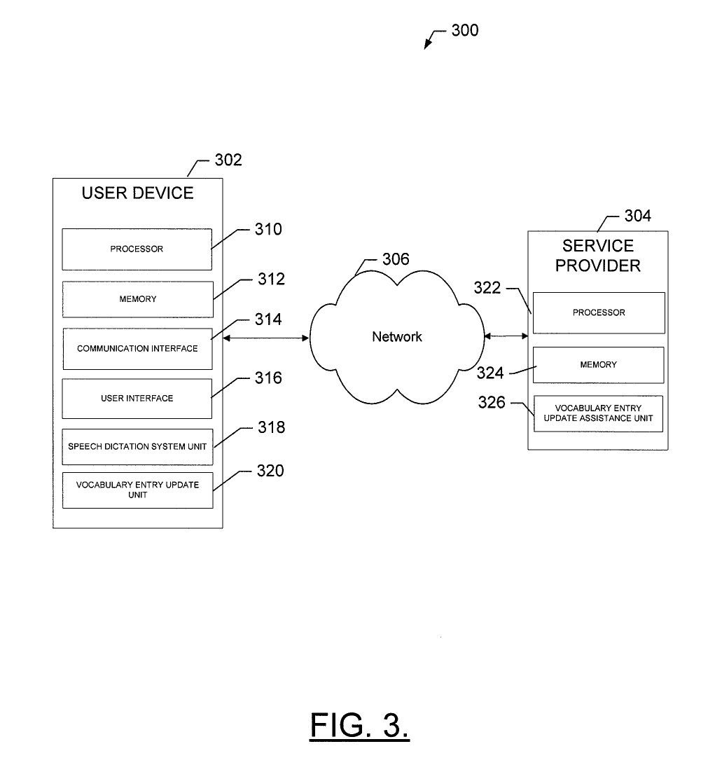

FIG. 3 illustrates a block diagram of a system 300 for providing a mixed language entry mobile speech dictation system according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. Further, as used herein, a “speech dictation system” refers to any automatic speech recognition system configured to receive speech data as input and generate textual output based upon the speech data input. “Mixed language entry” refers to speech data input comprising words from multiple languages. The system 300 will be described, for purposes of example, in connection with the mobile terminal 10 of FIG. 1 and the system 47 of FIG. 2. However, it should be noted that the system of FIG. 3, may also be employed in connection with a variety of other devices, both mobile and fixed, and therefore, embodiments of the present invention should not be limited to application on devices such as the mobile terminal 10 of FIG. 1. Further, it should be noted that the system of FIG. 3 may be used in connection with any of a variety of network configurations or protocols and is not limited to embodiments using aspects of the system 47 of FIG. 2. It should also be noted, that while FIG. 3 illustrates one example of a configuration of a system for providing a mixed language entry speech dictation system, numerous other configurations may also be used to implement embodiments of the present invention.

Referring now to FIG. 3, the system 300 may include a user device 302 and a service provider 304 configured to communicate with each other over a network 306. The user device 302 may be any computing device configured to implement and provide a user interface for a mixed language entry speech dictation system according to various embodiments of the present invention and in an exemplary embodiment, may be a mobile terminal 10. The service provider 304 may be embodied as any computing device, mobile or fixed, and may be embodied as a server, desktop computer, laptop computer, mobile terminal 10, and/or the like. The service provider 304 may also be embodied as a combination of a plurality of computing devices configured to provide network side services for a mixed language speech dictation system as implemented by a user device 302. In this regard, the service provider 304 may be embodied, for example, as a server cluster and/or may be embodied as a distributed computing system, such as may be distributed across a plurality of computing devices, such as, for example, mobile terminals 10. The network 306 may be any network over which the user device 302 and service provider 304 are configured to communicate. Accordingly, the network 306 may be a wireless or wireline network and in an exemplary embodiment may comprise the system 47 of FIG. 2. The network 306 may further utilize any communications protocol or combination of communications protocols that may facilitate inter-device communication between the user device 302 and service provider 304. Additionally, although the system 300 illustrates a single user device 302 and a single service provider 304 for purposes of example, the system 300 may include a plurality of user devices 302 and/or service providers 304.

The user device 302 may include various means, such as a processor 310, memory 312, communication interface 314, user interface 316, speech dictation system unit 318, and vocabulary entry update unit 320 for performing the various functions herein described. The processor 310 may be embodied as a number of different means. For example, the processor 310 may be embodied as a microprocessor, a coprocessor, a controller, or various other processing elements including integrated circuits such as, for example, an ASIC (application specific integrated circuit) or FPGA (field programmable gate array). The processor 310 may, for example, be embodied as the controller 20 of a mobile terminal 10. In an exemplary embodiment, the processor 310 may be configured to execute instructions stored in the memory 312 or otherwise accessible to the processor 310. Although illustrated in FIG. 3 as a single processor, the processor 310 may comprise a plurality of processors operating in parallel, such as a multi-processor system.

The memory 312 may include, for example, volatile and/or non-volatile memory. In an exemplary embodiment, the memory 312 may be embodied as, for example, volatile memory 40 and/or non-volatile memory 42 of a mobile terminal 10. The memory 312 may be configured to store information, data, applications, instructions, or the like for enabling the user device 302 to carry out various functions in accordance with exemplary embodiments of the present invention. For example, the memory 312 may be configured to buffer input data for processing by the processor 310. Additionally or alternatively, the memory 312 may be configured to store instructions for execution by the processor 310. As yet another alternative, the memory 312 may comprise one of a plurality of databases that store information in the form of static and/or dynamic information. In this regard, the memory 312 may store, for example, a language model, acoustic models, speech data input, vocabulary entries, phonetic models, pronunciation models, and/or the like for facilitating a mixed language entry speech dictation system according to any of the various embodiments of the invention. This stored information may be stored and/or used by the speech dictation system unit 318 and vocabulary entry update unit 320 during the course of performing their functionalities.

The communication interface 314 may be embodied as any device or means embodied in hardware, software, firmware, or a combination thereof that is configured to receive and/or transmit data from/to a network and/or any other device or module in communication with the user device 302. In one embodiment, the communication interface 314 may be at least partially embodied as or otherwise controlled by the processor 310. In this regard, the communication interface 314 may include, for example, an antenna, a transmitter, a receiver, a transceiver and/or supporting hardware or software for enabling communications with other entities of the system 300, such as a service provider 304 via the network 306. In this regard, the communication interface 314 may be in communication with the memory 312, user interface 316, speech dictation system unit 318, and/or vocabulary entry update unit 320. The communication interface 314 may be configured to communicate using any protocol by which the user device 302 and service provider 304 may communicate over the network 306.

The user interface 316 may be in communication with the processor 310 to receive an indication of a user input and/or to provide an audible, visual, mechanical, or other output to the user. As such, the user interface 316 may include, for example, a keyboard, a mouse, a joystick, a display, including, for example, a touch screen display, a microphone, a speaker, and/or other input/output mechanisms. In this regard, the user interface 316 may facilitate receipt of speech data provided, such as, for example, via a microphone, by a user of the user device 302. The user interface 316 may further facilitate display of text generated from received speech data by the speech dictation system unit 318 on a display associated with the user device 302. In this regard, in an exemplary embodiment, the user interface 316 may comprise, for example, a microphone 26 and display 28 of a mobile terminal 10. The user interface 316 may further be in communication with the speech dictation system unit 318 and vocabulary entry update unit 320. Accordingly, the user interface 316 may facilitate use of a mixed language entry speech dictation system, by a user of a user device 302.

The speech dictation system unit 318 may be embodied as various means, such as hardware, software, firmware, or some combination thereof and, in one embodiment, may be embodied as or otherwise controlled by the processor 310. In embodiments where the speech dictation system unit 318 is embodied separately from the processor 310, the speech dictation system unit 318 may be in communication with the processor 310. The speech dictation system unit 318 may be configured to process mixed language speech data input received from a user of the user device 302 and translate the received mixed language speech data into corresponding textual output. Accordingly, the speech dictation system 318 may be configured to provide a mixed language speech dictation system through automatic speech recognition as will be further described herein.

The vocabulary entry update unit 320 may be embodied as various means, such as hardware, software, firmware, or some combination thereof and, in one embodiment, may be embodied as or otherwise controlled by the processor 310. In embodiments where the vocabulary entry update unit 320 is embodied separately from the processor 310, the vocabulary entry update unit 320 may be in communication with the processor 310. The vocabulary entry update unit 320 may be configured to receive textual vocabulary entry data and to identify one or more candidate languages for the received textual vocabulary entry data. In this regard, a candidate language is a language which the vocabulary entry data may be native to or otherwise belong to, such as with some degree of likelihood determined by the vocabulary entry update unit 320. As used herein, “vocabulary entry data” may comprise a word, a plurality of words, and/or other alphanumeric sequence. Vocabulary entry data may be received from, for example, a language model of the speech dictation system unit 318; from an application of the user device 302, such as, for example, an address book, contacts list, calendar application, and/or a navigation service; from message received by or sent from the user device 302, such as, for example, a short message service (SMS) message, an e-mail, an instant message (IM), and/or a multimedia messaging service (MMS) message; and/or directly from user input into a user device 302. Accordingly, the vocabulary entry update unit 320 may be configured to parse or otherwise receive textual vocabulary entry data from an application of and/or a message received by or sent from a user device 302.

The vocabulary entry update unit 320 may further be configured to generate one or more language-dependent pronunciation models for the received textual vocabulary entry data based upon the identified one or more languages. These pronunciation models may comprise phoneme sequences for the vocabulary entry data. In this regard, the vocabulary entry update unit 320 may be configured to access one or more pronunciation modeling schemes to generate language-dependent phoneme sequences for the vocabulary entry data. The generated pronunciation models may then be provided to the speech dictation system unit 318 for use in the mixed language speech dictation system provided by embodiments of the present invention. Although in one embodiment all of the vocabulary entry update functionality may be embodied in the vocabulary entry update unit 320 on a user device 302, in an exemplary embodiment, at least some of the functionality may be embodied on the service provider 304 and facilitated by the vocabulary entry update assistance unit 326 thereof. In particular, for example, the vocabulary entry update unit 320 may be configured to communicate with the vocabulary entry update assistance unit 326 to access online language-dependent pronunciation modeling schemes embodied on the service provider 304.

Referring now to the service provider 304, the service provider 304 may be any computing device or plurality of computing devices configured to support a mixed language speech dictation system at least partially embodied on a user device 302. In an exemplary embodiment, the service provider 304 may be embodied as a server or a server cluster. The service provider 304 may include various means, such as a processor 322, memory 324, and vocabulary entry update assistance unit 326 for performing the various functions herein described. The processor 322 may be embodied as a number of different means. For example, the processor 322 may be embodied as a microprocessor, a coprocessor, a controller, or various other processing elements including integrated circuits such as, for example, an ASIC (application specific integrated circuit) or FPGA (field programmable gate array). In an exemplary embodiment, the processor 322 may be configured to execute instructions stored in the memory 324 or otherwise accessible to the processor 322. Although illustrated in FIG. 3 as a single processor, the processor 322 may comprise a plurality of processors operating in parallel, such as a multi-processor system. In embodiments wherein the processor 322 is embodied as multiple processors, the processors may be embodied in a single computing device or distributed among multiple computing devices, such as a server cluster or amongst computing devices in operative communication with each other over a network.

The memory 324 may include, for example, volatile and/or non-volatile memory. The memory 324 may be configured to store information, data, applications, instructions, or the like for enabling the service provider 304 to carry out various functions in accordance with exemplary embodiments of the present invention. For example, the memory 324 may be configured to buffer input data for processing by the processor 322. Additionally or alternatively, the memory 324 may be configured to store instructions for execution by the processor 322. As yet another alternative, the memory 324 may comprise one of a plurality of databases that store information in the form of static and/or dynamic information. In this regard, the memory 324 may store, for example, a language model, acoustic models, speech data input, vocabulary entries, phonetic models, pronunciation models, and/or the like for facilitating a mixed language entry speech dictation system according to any of the various embodiments of the invention. This stored information may be stored and/or used by the vocabulary entry update assistance unit 326, the speech dictation system unit 318 of a user device 302, and/or the vocabulary entry update unit 320 of a user device 302 during the course of performing their functionalities.

The vocabulary entry update assistance unit 326 may be embodied as various means, such as hardware, software, firmware, or some combination thereof and, in one embodiment, may be embodied as or otherwise controlled by the processor 322. In embodiments where the vocabulary entry update assistance unit 326 is embodied separately from the processor 322, the vocabulary entry update assistance unit 326 may be in communication with the processor 322. The vocabulary entry update assistance unit 326 may be configured to assist the vocabulary entry update unit 320 of a user device 302 in the generation of pronunciation models, such as phoneme sequences, for textual vocabulary entry data. In an exemplary embodiment, the vocabulary entry update assistance unit 326 may apply one or more language-dependent pronunciation modeling schemes to vocabulary entry data. Although only illustrated as a single vocabulary entry update assistance unit 326, the system of FIG. 3 may include a plurality of vocabulary entry update assistance units 326, each of which may be configured to apply a particular language-dependent pronunciation modeling scheme.

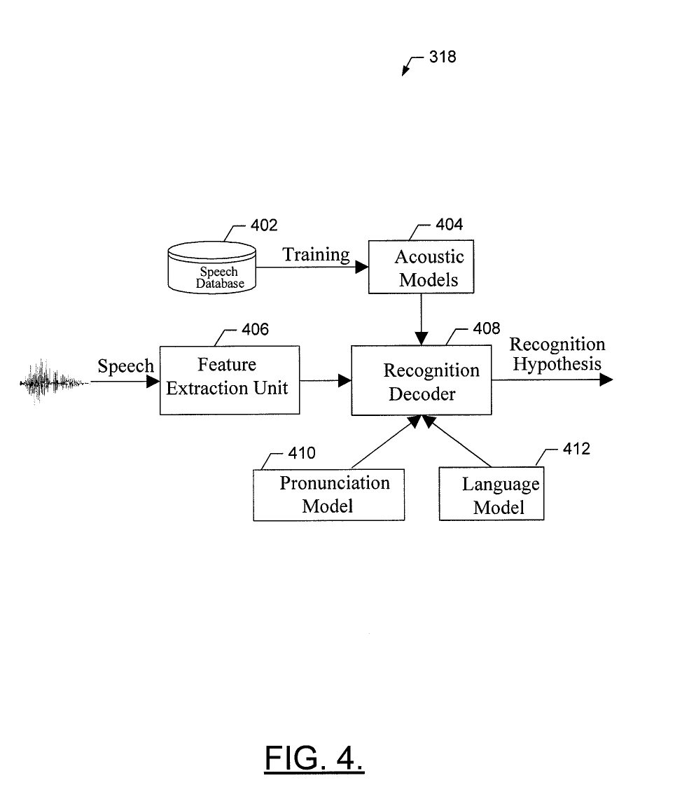

Referring now to FIG. 4, a block diagram of a speech dictation system unit 318 according to an exemplary embodiment of the present invention is illustrated. The speech dictation system unit 318 may include a feature extraction unit 406, recognition decoder 408, acoustic models 404, pronunciation model 410, and language model 412. The speech dictation system unit 318 may be configured to access a pre-recorded speech database 402, such as may be stored in memory 312 for purposes of training acoustic models of the speech dictation system unit 318. The feature extraction unit 406 may be configured to receive speech data input and the recognition decoder 408 may be configured to output a textual representation of the speech data input.

In particular, the feature extraction unit 406 front end may produce a feature vector sequence of equally spaced discrete acoustic observations. The recognition decoder 408 may compare feature vector sequences to one or more pre-estimated acoustic model patterns (e.g., Hidden Markov Models (HMMs)) selected from or otherwise provided by the acoustic models 404. The acoustic modeling may be performed at the phoneme level. The pronunciation model 410 may convert each word into phonetic level, so that phoneme-based acoustic models may form the word model accordingly. The language model 412 (LM) may assign a statistical probability to a sequence of words by means of a probability distribution to optimally decode speech input given the word hypothesis from the recognition decoder 408. In this regard, the LM may capture properties of one or more languages, model the grammar of the language(s) in a data-driven manner, and predict the next word in a speech sequence.

Mathematically, speech recognition by the recognition decoder 408 may be performed using probabilistic modeling approach. In this regard, the goal is to find the most likely sequence of words, W, given the acoustic observation A. The expression may be written using Bayes's rule:

$${max}_{W} P ( W \vert A ) = {max}_{W} P ( A \vert W ) \cdot P ( W ) \qquad ( 1 )$$

A language may be modeled using n-gram statistics and trained on the training text corpus. Given any sentence consisting of word sequence: w₁ w₂ . . . w_{N}, we have n-gram:

$$P ( W ) = {\prod }_{i = 1}^{N} P ( {w}_{i} \vert {w}_{i - n + 1} … {w}_{i - 1} ) \qquad ( 2 )$$

Assuming that one word wᵢ can be uniquely assigned to only one class cᵢ, then we have class-based LM:

$$\begin{matrix}P ( W ) = {\prod }_{i = 1}^{N} P ( {w}_{i} \vert {w}_{i - n + 1} … {w}_{i - 1} ) \\ = {\prod }_{i = 1}^{N} P ( {w}_{i} \vert {c}_{i - n + 1} … {c}_{i - 1} ) \\ = {\prod }_{i = 1}^{N} P ( {w}_{i} \vert {c}_{i} ) \cdot P ( {c}_{i} \vert {c}_{i - n + 1} … {c}_{i - 1} )\end{matrix} \qquad ( 3 )$$

This class-based language model benefits speech dictation systems, and in particular may benefit a mobile speech dictation system in accordance with some embodiments of the invention wherein the user device 302 is a mobile computing device, such as a mobile terminal 10. In this regard, computing devices, and in particular mobile computing devices, contain personal data that may frequently change or otherwise is updated. Accordingly, it is important to support open vocabularies to which users may instantly add new words from contacts, calendar applications, messages, and/or the like. Class-based LM provides a way to efficiently add these new words into a LM. Additionally, use of class-based LM may provide a solution for data sparseness problems that may otherwise occur in LMs. Use of a class-based LM may further provide a mechanism for rapid LM adaptation and may particularly be advantageous for embodiments of the invention wherein the speech dictation system unit is embodied as an embedded system within the user device 302. The class may be defined in a number of ways in accordance with various embodiments of the invention, and may be defined using, for example, rule-based and/or data-driven definitions. For example, the syntactic-semantic information may be used to produce a number of classes. Embodiments of the present invention may cluster together words that have similar semantic functional role, such as named entities. The class-based LM may be initially offline trained using text corpus. The LM may then be adapted to acquire a named entity or other word, such as from an application of the user device 302, such as, for example, an address book, contacts list, calendar application, and/or a navigation service; from message received by or sent from the user device 302, such as, for example, a short message service (SMS) message, an e-mail, an instant message (IM), and/or a multimedia messaging service (MMS) message; and/or directly from user input into a user device 302. The new words may be placed into the LM. In this regard, name entities may be placed in the name entity class of the LM.
The words may be represented as sequence of phonetic units U, for example of phonemes. Then the expression may be expanded to:

$${max}_{W} P ( W \vert A ) = {max}_{W} P ( A \vert W ) \cdot P ( W ) = {max}_{U , W} P ( A \vert U ) \cdot P ( U \vert W ) \cdot P ( W ) \qquad ( 4 )$$

Accordingly, the pronunciation model 410 and language model 412 may provide constraint for recognition by the recognition decoder 408. In this regard, the recognition decoder 408 may be built on the language model 412, and each word in the speech dictation system may be represented at the phonetic level using a pronunciation model, and each phonetic unit may be further represented by a phonetic acoustic model. Finally, the recognition decoder 408 may perform a Viterbi search on the composite speech dictation system to find the most likely sentence for a speech data input.

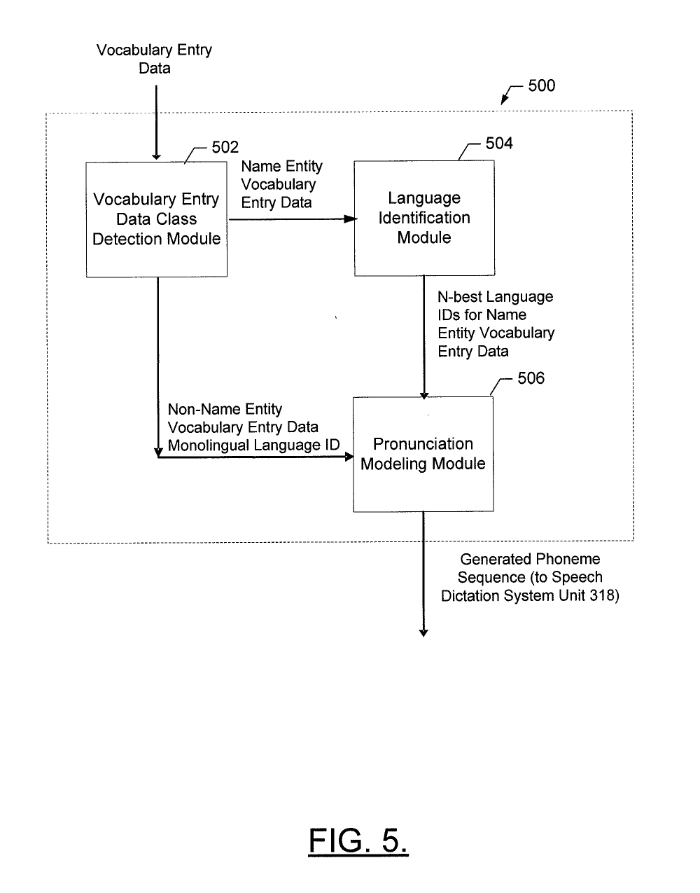

Referring now to FIG. 5, a block diagram of a system 500 for providing mixed language vocabulary entries for a mixed language speech dictation system according to an exemplary embodiment of the present invention is illustrated. The system 500 may include a vocabulary entry data class detection module 502, language identification module 504, and pronunciation modeling module 506. The system 500 may be in communication with the speech dictation system unit 318. In this regard, the vocabulary entry update unit 320 of a user device 302 and/or the vocabulary entry update assistance unit 326 of a service provider 304 may comprise the system 500. The system 500 may further be in communication with the vocabulary entry update assistance unit 326 of a service provider 304. In some embodiments, certain elements of the system 500 may be embodied as or otherwise comprise the vocabulary entry update assistance unit 326. In one embodiment, for example, the pronunciation modeling module 506 may comprise the vocabulary entry update assistance unit 326.

The vocabulary entry data class detection module 502 may be configured to receive vocabulary entry data and determine a class for the vocabulary entry data. Vocabulary entry data may be received from, for example, the language model 412 of the speech dictation system unit 318. In this regard, the language model 412 may have received vocabulary entry data from an application of the user device 302, such as, for example, an address book, contacts list, calendar application, and/or a navigation service; from message received by or sent from the user device 302, such as, for example, a short message service (SMS) message, an e-mail, an instant message (IM), and/or a multimedia messaging service (MMS) message; and/or directly from user input into a user device 302. Additionally or alternatively, the vocabulary entry data class detection module 502 may be configured to receive vocabulary entry data directly from an application of the user device 302, such as, for example, an address book, contacts list, calendar application, and/or a navigation service; from message received by or sent from the user device 302, such as, for example, a short message service (SMS) message, an e-mail, an instant message (IM), and/or a multimedia messaging service (MMS) message; and/or directly from user input into a user device 302. Accordingly, the vocabulary entry data class detection module 502 may be configured to parse or otherwise receive textual vocabulary entry data from an application of and/or a message received by or sent from a user device 302. In embodiments where the vocabulary entry data class detection module 502 receives or parses vocabulary entry data from an application, message, or user input, the vocabulary entry data class detection module 502 may be configured to provide the vocabulary entry data to the language model 412 so that the language model 412 includes all vocabulary entries recognized by the speech dictation system 318.

The vocabulary entry data class detection module 502 may be further configured to determine and uniquely assign a class to each word comprising received vocabulary entry data. In an exemplary embodiment, the vocabulary entry data class detection module may determine whether received vocabulary entry data is a “name entity” or a “non-name entity.” A name entity may comprise, for example, a name of a person, a name of a location, and/or a name of an organization. A non-name entity may comprise, for example, any other word.

The vocabulary entry data class detection module may be configured to determine a class for received vocabulary entry data by any of several means. Some received vocabulary entry data may have a pre-associated or otherwise pre-identified class association, which may be indicated, for example, through metadata. Accordingly, the vocabulary entry data class detection module 502 may be configured to determine a class by identifying the indicated pre-associated class association. In this regard, for example, vocabulary entry data may be received from the language model 412, which in an exemplary embodiment may be class-based. Accordingly, the vocabulary entry data class detection module 502 may be configured to determine the class of vocabulary entry data received from a class-based language model 412 based on the pre-associated class association, wherein cᵢ=P(wᵢ). Additionally, or alternatively, the vocabulary entry data class detection module 502 may be configured to determine a class based upon a context of the received vocabulary entry data. For example, vocabulary entry data received or otherwise parsed from a name entry of a contacts list or address book application may be determined to be a name entity. Further, vocabulary entry data received or otherwise parsed from a recipient or sender field of a message may be determined to be a name entity. In another example, the vocabulary entry data class detection module 502 may receive location, destination, or other vocabulary entry data from a navigation service that may be executed on the user device 302 and may determine such vocabulary entry data to be a name entity. Additionally or alternatively, the vocabulary entry data class detection module 502 may be configured to determine a class based upon the grammatical context of textual data from which vocabulary entry data was received or otherwise parsed.

If the vocabulary entry data class detection module 502 determines that received vocabulary entry data is a non-name entity, the vocabulary entry data class detection module may be further configured to identify a language for the vocabulary entry data. In this regard, the vocabulary entry data class detection module 502 may identify and assign a preset or default language, which may be a monolingual language, to the vocabulary entry data. This preset monolingual language may be the native or default language of the speech dictation system. In this regard, for example, the preset monolingual language identification may correspond to the native language of a user of a user device 302. If, however, the vocabulary entry data class detection module 502 determines that received vocabulary entry data is a name entity, the vocabulary entry data class detection module may send the name entity vocabulary entry data to the language identification module 504.

The language identification module 504 may be configured to identify one or more candidate languages for the name entity vocabulary entry data. In this regard, a candidate language is a language which the vocabulary entry data may be native to or otherwise belong to, such as with some degree of likelihood. The language identification module 504 may be configured to identify the N-best candidate languages for a given vocabulary entry data. In this regard, N-best may refer to any predefined constant number of candidate languages which the language identification module 504 identifies for the vocabulary entry data. Additionally or alternatively, the language identification module 504 may be configured to identify one or more candidate languages to which the name entity vocabulary data entry may belong to with a statistical probability above a certain threshold. The language identification module 504 may then assign the one or more identified languages to the vocabulary entry data. In this regard, a pronunciation model may be generated for the name entity vocabulary entry data as later described for each candidate language so as to train the speech dictation system to accurately generate textual output from received speech data. The language identification module 504 may further be configured to identify a preset or default language and assign that language to the name entity vocabulary entry data as well. In this regard, a pronunciation model may be generated for the name entity in accordance with a user's native language to account for mispronunciations of foreign language name entities that may be anticipated based upon pronunciation conventions of a user's native language.

Embodiments of the language identification module 504 that identify and assign multiple languages to a name entity vocabulary entry data may provide an advantage in that the appropriate language for the vocabulary entry data may generally be among the plurality, such as N-best, identified languages. Accordingly, the accuracy of pronunciation model generation may be improved over embodiments wherein only a single language is identified and assigned as the single identified language may not be accurate and/or may not account for users who may pronounce non-native language name entities in a heavily accented manner that may not be covered by an otherwise appropriate language model for the name entity.

The language identification module 504 may be configured to use any one or more of several modeling techniques for text-based language identification. These techniques may include, but are not limited to, neural networks, multi-layer perception (MLP) networks, decision trees, and/or N-grams. In embodiments where the language identification module 504 is configured to identify languages using an MLP network, the input of the network may comprise the current letter and the letters on the left and on the right of the current letter for the vocabulary entry data. Thus, the input to the MLP network may be a window of letters that may be slid across the word by the language identification module 504. In an exemplary embodiment, up to four letters on the left and on the right of the current letter may be included in the window. Since the neural network input units are continuous valued, the letters in the input window may need to be transformed to some numeric quantity. The language identification module 504 may feed the coded input into the neural network. The output units of the neural network correspond to the languages. Softmax normalization may be applied at the output layer. The softmax normalization may ensure that the network outputs are in the range [0,1] and sum up to unity. The language identification module 504 may order the languages, for example, according to their scores so that the scores may be used to identify one or more languages to assign to the vocabulary entry data.

Once one or more languages have been identified based on the textual representation of the vocabulary entry data, the pronunciation modeling module 506 may be configured to apply a pronunciation modeling scheme to the vocabulary entry data to generate a phoneme sequence associated with the vocabulary entry. In this regard, the pronunciation modeling module 506 may be configured to apply an appropriate language-dependent pronunciation modeling scheme to the vocabulary entry data for each associated language identified by the vocabulary entry data class detection module 502 and/or language identification module 504. Accordingly, the pronunciation modeling module may be configured to generate a phoneme sequence for the vocabulary entry data for each identified language so as to improve the accuracy and versatility of the speech dictation system unit 318 with respect to handling mixed language entries.

With regard to the pronunciation modeling schemes, the pronunciation modeling schemes may be online pronunciation modeling schemes so as to handle dynamic and/or user specified vocabulary data entries. In some embodiments, the pronunciation modeling schemes may be embodied on a remote network device and accessed by the vocabulary entry update unit 320 of the user device 302. In an exemplary embodiment, the online pronunciation modeling schemes may be accessed by the vocabulary entry update unit 320 through the vocabulary entry update assistance unit 326 of the service provider 304. It will be appreciated, however, that embodiments of the invention are not limited to use of online pronunciation modeling schemes from a remote service provider, such as the service provider 304, and indeed some embodiments of the invention may use pronunciation modeling schemes that may be embodied locally on the user device 302. In an exemplary embodiment, the online pronunciation modeling schemes may be used to facilitate dynamic, user-specified vocabularies which may be updated with vocabulary entry data received as previously described. In this regard, it may be difficult to create pronunciation dictionaries that may cover all possible received vocabulary entry data given the large memory footprint of such a universal pronunciation dictionary. The pronunciation modeling schemes may, for example, store pronunciations of the most likely entries of a language in a look-up table. The pronunciation modeling schemes may be configured to use any one or more of several methods for text-to-phoneme (T2P) mapping of vocabulary entry data. These methods may include, for example, but are not limited to pronunciation rules, neural networks, and/or decision trees. For structured languages, like Finnish or Japanese, accurate pronunciation rules may be found and accordingly language-dependent pronunciation modeling schemes for structured languages may be configured to use pronunciation rules. For non-structured languages, like English, it may be difficult to produce a finite set of T2P rules, which may characterize the pronunciation of a language accurately enough. Accordingly, language-dependent pronunciation modeling schemes for non-structured languages may be configured to use decision trees and/or neural networks for T2P mapping.

Once the pronunciation modeling module 506 has generated a phoneme sequence for the vocabulary entry data for each identified language, the generated phoneme sequence(s) may be provided to the speech dictation system unit 318. The recognition network of the speech dictation system unit 318 may then be built on the language model, and each word model may be constructed as a concatenation of the acoustic models according to the phoneme sequence. Using these basic modules the recognition decoder 408 of the speech dictation system unit 318 may automatically cope with mixed language vocabulary entries without any assistance from the user.

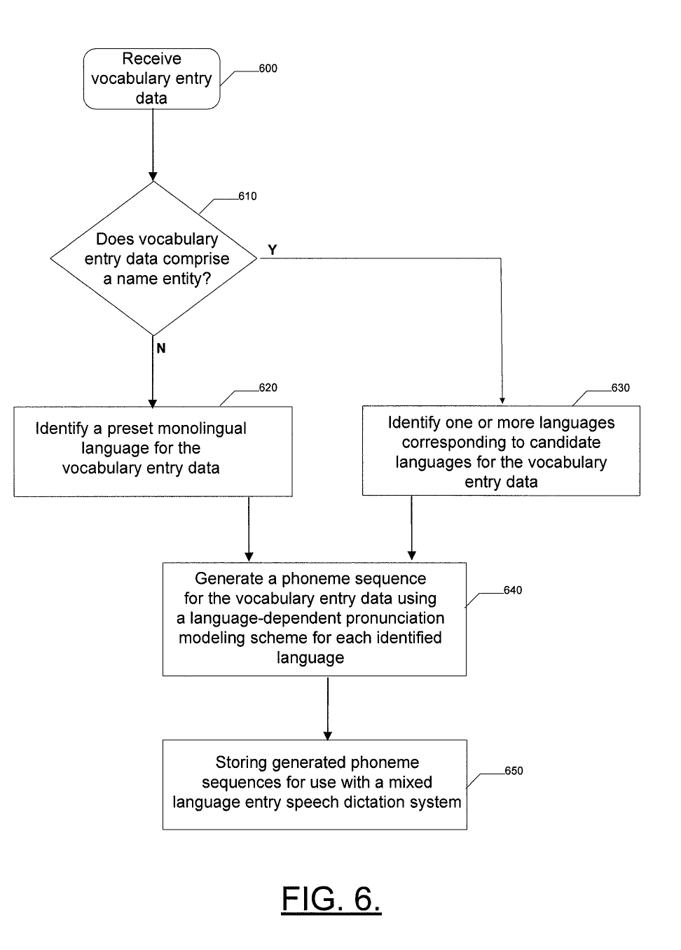

FIG. 6 is a flowchart of a system, method, and computer program product according to an exemplary embodiment of the invention. It will be understood that each block or step of the flowchart, and combinations of blocks in the flowchart, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a built-in processor in the computing device. In some embodiments, the computer program instructions which embody the procedures described above may be stored by memory devices of a plurality of computing devices. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowcharts, and combinations of blocks or steps in the flowchart, may be implemented by special purpose hardware-based computer systems which perform the specified functions or steps, or combinations of special purpose hardware and computer instructions.

In this regard, one exemplary method for providing a mixed language entry speech dictation system according to an exemplary embodiment of the present invention is illustrated in FIG. 6. The method may include the vocabulary entry data class detection module 502 receiving vocabulary entry data at operation 600. This vocabulary entry data may be received according to any of the methods described above, such as from the language model 412, from an application embodied on the user device 302, and/or from content of a message sent from or received by the user device 302. Operation 610 may comprise the vocabulary entry data class detection module 502 determining whether the vocabulary entry data comprises a name entity. If the vocabulary entry data is determined to be a non-name entity, the vocabulary entry data class detection module 502 may identify a preset language for the vocabulary entry data at operation 620. If, however, the vocabulary entry data is determined to be a name entity, the language identification module 504 may identify one or more languages corresponding to candidate languages for the vocabulary entry data at operation 630. Operation 640 may comprise the pronunciation modeling module 506 generating a phoneme sequence for the vocabulary entry data for each identified language. In this regard, the pronunciation modeling module 506 may use, for example, one or more language-dependent pronunciation modeling schemes. Operation 650 may comprise the pronunciation modeling module storing or otherwise providing the generated phoneme sequence(s) for use with a mixed language entry speech dictation system. In this regard, generated phoneme sequences may be stored in the pronunciation model 410, such as in a pronunciation lookup table, and used for building the decoder network used by the speech dictation system unit 318.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device, such as a mobile terminal 10. Embodiments of the invention may provide for a mixed language entry speech dictation system. Accordingly, users may benefit from an automatic speech recognition system that may facilitate dictation of sentences comprised of words, such as name entities, that may be in languages different from the language of the main part of the sentence. Embodiments of the invention may thus allow for the improvement of monolingual speech recognition systems to handle mixed language entry without requiring implementation of full blown multilingual speech recognition systems to handle mixed language entries. Accordingly, computing resources used by mixed language entry speech dictation systems in accordance with embodiments of the present invention may be limited.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving vocabulary entry data;
determining a class for the received vocabulary entry data;
identifying one or more languages for the vocabulary entry data based upon the determined class; and
generating a phoneme sequence for the vocabulary entry data for each identified language.

2. A method according to claim 1, wherein determining a class for the received vocabulary entry data comprises determining whether the received vocabulary entry data is a name entity or a non-name entity.

3. A method according to claim 2, wherein identifying one or more languages comprises:
identifying a preset language for the vocabulary entry data if the vocabulary entry data is determined to be a non-name entity; and
identifying one or more languages corresponding to candidate languages for the vocabulary entry data if the vocabulary entry data is determined to be a name entity.

4. A method according to claim 2, wherein name entity vocabulary entry data comprises a name of a person, a name of a location, or a name of an organization.

5. A method according to claim 1, wherein generating a phoneme sequence for the vocabulary entry data comprises generating a phoneme sequence for the vocabulary entry data using a language-dependent pronunciation modeling scheme corresponding to an identified language for the vocabulary entry data.

6. A method according to claim 5, wherein the language-dependent pronunciation modeling scheme is at least partially embodied on a remote network-accessible device.

7. A method according to claim 1, further comprising storing generated phoneme sequences for use with a mixed language entry speech dictation system.

8. A method according to claim 7, wherein the mixed language entry speech dictation system is embodied on a mobile terminal.

9. A method according to claim 1, wherein receiving vocabulary entry data comprises receiving vocabulary entry data from a language model, an address book, a contacts list, a calendar application, a short message service message, an e-mail, an instant message, a multimedia messaging service message, a navigation service, or from a user.

10. A computer program product comprising at least one computer-readable storage medium having computer-readable program code portions stored therein, the computer-readable program code portions comprising:
a first program code portion for receiving vocabulary entry data;
a second program code portion for determining a class for the received vocabulary entry data;
a third program code portion for identifying one or more languages for the vocabulary entry data based upon the determined class; and
a fourth program code portion for generating a phoneme sequence for the vocabulary entry data for each identified language.

11. A computer program product according to claim 10, wherein the second program code portion includes instructions for determining whether the received vocabulary entry data is a name entity or a non-name entity.

12. A computer program product according to claim 11, wherein the third program code portion includes instructions for:
identifying a preset language for the vocabulary entry data if the vocabulary entry data is determined to be a non-name entity; and
identifying one or more languages corresponding to candidate languages for the vocabulary entry data if the vocabulary entry data is determined to be a name entity.

13. A computer program product according to claim 11, wherein name entity vocabulary entry data comprises a name of a person, a name of a location, or a name of an organization.

14. A computer program product according to claim 10, wherein the fourth program code portion includes instructions for generating a phoneme sequence for the vocabulary entry data using a language-dependent pronunciation modeling scheme corresponding to an identified language for the vocabulary entry data.

15. A computer program product according to claim 14, wherein the language-dependent pronunciation modeling scheme is at least partially embodied on a remote network-accessible device.

16. A computer program product according to claim 10, further comprising:
a fifth program code portion for storing generated phoneme sequences for use with a mixed language entry speech dictation system.

17. A computer program product according to claim 16, wherein the mixed language entry speech dictation system is embodied on a mobile terminal.

18. A computer program product according to claim 10, wherein the first program code portion includes instructions for receiving vocabulary entry data from a language model, an address book, a contacts list, a calendar application, a short message service message, an e-mail, an instant message, a multimedia messaging service message, a navigation service, or from a user.

19. An apparatus comprising a processor configured to:
receive vocabulary entry data;
determine a class for the received vocabulary entry data;
identify one or more languages for the vocabulary entry data based upon the determined class; and
generate a phoneme sequence for the vocabulary entry data for each identified language.

20. An apparatus according to claim 19, wherein the processor is configured to determine a class for the received vocabulary entry data by determining whether the received vocabulary entry data is a name entity or a non-name entity.

21. An apparatus according to claim 20, wherein the processor is configured to identify one or more languages by:
identifying a preset language for the vocabulary entry data if the vocabulary entry data is determined to be a non-name entity; and
identifying one or more languages corresponding to candidate languages for the vocabulary entry data if the vocabulary entry data is determined to be a name entity.

22. An apparatus according to claim 20, wherein name entity vocabulary entry data comprises a name of a person, a name of a location, or a name of an organization.

23. An apparatus according to claim 19 wherein the processor is configured to generate a phoneme sequence for the vocabulary entry data using a language-dependent pronunciation modeling scheme corresponding to an identified language for the vocabulary entry data.

24. An apparatus according to claim 23 wherein the language-dependent pronunciation modeling scheme is at least partially embodied on a remote network-accessible device.

25. An apparatus according to claim 19, wherein the processor is further configured to store generated phoneme sequences for use with a mixed language entry speech dictation system.

26. An apparatus according to claim 25, wherein the mixed language entry speech dictation system is embodied on a mobile terminal.

27. An apparatus according to claim 19, wherein the processor is configured to receive vocabulary entry data from a language model, an address book, a contacts list, a calendar application, a short message service message, an e-mail, an instant message, a multimedia messaging service message, a navigation service, or from a user.

28. An apparatus comprising:
means for receiving vocabulary entry data;
means for determining a class for the received vocabulary entry data;
means for identifying one or more languages for the vocabulary entry data based upon the determined class; and
means for generating a phoneme sequence for the vocabulary entry data for each identified language.

29. An apparatus according to claim 28, wherein the means for determining a class for the received vocabulary entry data comprises means for determining whether the received vocabulary entry data is a name entity or a non-name entity.

30. An apparatus according to claim 29, wherein the means for identifying one or more languages comprises:
means for identifying a preset language for the vocabulary entry data if the vocabulary entry data is determined to be a non-name entity; and
means for identifying one or more languages corresponding to candidate languages for the vocabulary entry data if the vocabulary entry data is determined to be a name entity.

31. An apparatus according to claim 28, wherein the means for generating a phoneme sequence for the vocabulary entry data comprises means for generating a phoneme sequence for the vocabulary entry data using a language-dependent pronunciation modeling scheme corresponding to an identified language for the vocabulary entry data.
